(19) United States
(12) Patent Application Publication
(10) Pub. No.: US 2026/0345416 A1
(43) Pub. Date: Nov. 5, 2026

(54) MASSAGING DEVICE

(71) Applicant: Michael Wang, Chamblee, GA (US)

(72) Inventors: Michael Wang, Chamblee, GA (US); Arthur Wu, Las Vegas, NV (US)

(21) Appl. No.: 19/199,005

(22) Filed: May 5, 2025

(51) Int. Cl. A61H 1/00; A61H 15/00; A61H 23/00

(52) U.S. Cl. CPC A61H 1/006; A61H 15/0092; A61H 23/006; A61H 2015/005; A61H 2015/0071; A61H 2201/0119; A61H 2201/0161; A61H 2201/0207; A61H 2201/0214; A61H 2201/1253; A61H 2201/1676; A61H 2201/1685; A61H 2203/0456; A61H 2205/04

(57) ABSTRACT

The disclosure includes a massaging device including a housing defining a perimeter and a central open area, at least one mount coupled to the housing along the perimeter, and at least one head detachably coupled to the at least one mount. In some embodiments, the central open area is configured to receive a portion of a user's body, and the at least one head is configured to provide pressure to the user's body. The housing may include an enclosed shape.

### TECHNICAL FIELD

The present disclosure relates to massaging devices, particularly, neck massaging devices.

### BACKGROUND

Neck pain impacts 30-50% of adults, with 50% to 80% of those people not getting complete resolution from pain. Common symptoms of neck pain are shoulder pain, neck stiffness, numbness in the fingers, headaches, and jaw pain. Effective treatment for neck pain in physical therapy usually involves Spinal Manipulation, Therapeutic exercise, Manual Trigger point release, Dry Needling, Cervical Traction, and Manual Massage. Although effective, over time, neck pain often returns due to many factors such as poor sleep, stress, sports injury, aging, poor posture, and phone and computer use. There is a need for an improved device to provide relief from neck pain, as well as pain in other parts of the body.

### SUMMARY OF THE INVENTION

The disclosure includes a massaging device including a housing defining a perimeter and a central open area, at least one mount coupled to the housing along the perimeter, and at least one head detachably coupled to the at least one mount. In some embodiments, the central open area is configured to receive a portion of a user's body, and the at least one head is configured to provide pressure to the user's body. The housing may include an enclosed shape.

In some embodiments, the at least one head includes a plurality of heads each coupled to a corresponding mount. The plurality of heads may be spaced apart about the housing so as to be configured to provide symmetrical pressure about the user's body. In some embodiments, each head of the at least one head includes a therapeutic portion having a configuration selected from the group consisting of a first configuration, a second configuration, a third configuration, and a fourth configuration.

The first configuration may correspond to a first portion of the user's body, the second configuration may correspond to a second portion of the user's body, the third configuration may correspond to a third portion of the user's body, and the fourth configuration may correspond to a fourth portion of the user's body. In some embodiments, each of the first configuration, the second configuration, the third configuration, and the fourth configuration is configured to provide massaging pressure to each respective portion of the user's body.

The first configuration may correspond to a first user defining a first body size, the second configuration may correspond to a second user defining a second body size, the third configuration may correspond to a third user defining a third body size, and the fourth configuration may correspond to a fourth user defining a fourth body size. In some embodiments, each of the first configuration, the second configuration, the third configuration, and the fourth configuration is configured to provide massaging pressure to the first user, the second user, the third user, and the fourth user, respectively.

The at least one head may include a first head having a first configuration, wherein the first configuration may correspond to a first portion of the user's body and may be configured to provide massaging pressure to the first portion. In some embodiments, the at least one head includes a second head having a second configuration, wherein the second configuration corresponds to a second portion of the user's body and is configured to provide massaging pressure to the second portion. The at least one head may include a third head having a third configuration, wherein the third configuration may correspond to a third portion of the user's body and may be configured to provide massaging pressure to the third portion. In some embodiments, each of the first head, the second head, and the third head is configured to interchangeably couple to each mount of the at least one mount.

The massaging device may include a base configured to receive and store the housing. In some embodiments, the massaging device is configured to be used while the housing is coupled to the base to thereby provide cervical traction to the user.

The housing may include a plurality of segments mechanically coupled together to form the perimeter of the housing. In some embodiments, at least one segment of the plurality of segments is configured to be removed to reduce a size of the housing, and at least one additional segment is configured to be added to the plurality of segments to increase the size of the housing.

The massaging device may include a heat element electrically coupled to the massaging device. In some embodiments, the heat element is configured to warm a head of the at least one head and provide heat therapy to the user. The massaging device may include a percussion element electrically coupled to the massaging device. In some embodiments, the percussion element is configured to cause a head of the at least one head to vibrate and provide percussion therapy to the user.

The disclosure includes a massaging device including a ring defining a perimeter and a central open area, a mount coupled to the ring along the perimeter, and a head detachably coupled to the mount, wherein the head includes a therapeutic portion having a configuration selected from the group consisting of a first configuration, a second configuration, a third configuration, and a fourth configuration. In some embodiments, the central open area is configured to receive a portion of a user's body, and the therapeutic portion of the head is configured to provide pressure to the user's body.

The therapeutic portion of the head may include a first raised portion, a second raised portion spaced from the first raised portion, and a middle area located therebetween. In some embodiments, the first raised portion and the second raised portion are configured to provide pressure to the user's body. The first raised portion may include a first treatment element integrated into an end of the first raised portion, and the second raised portion may include a second treatment element integrated into an end of the second raised portion. In some embodiments, when the head is coupled to the mount, the first raised portion and the second raised portion extend away from the mount towards the central open area.

The first configuration may include the first treatment element of the first raised portion angled toward the middle area of the therapeutic portion and the second treatment element of the second raised portion angled toward the middle area of the therapeutic portion. In some embodiments, the second configuration includes the first treatment element of the first raised portion pointed toward the central open area of the ring and the second treatment element of the second raised portion pointed toward the central open area of the ring. The third configuration may include the first treatment element of the first raised portion angled away from the middle area of the therapeutic portion and the second treatment element of the second raised portion angled away from the middle area of the therapeutic portion.

In some embodiments, the massaging device includes a heat element electrically coupled to the massaging device, the heat element configured to warm the head and provide heat therapy to the user; a percussion element electrically coupled to the massaging device, the percussion element configured to cause the head to vibrate and provide percussion therapy to the user; a docking station configured to receive and store the ring, the docking station further configured to charge at least one of the heat element and the percussion element; or combinations thereof.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a perspective view of a user using the massaging device, according to some embodiments.

FIG. 2 illustrates a perspective view of the massaging device coupled to a base, according to some embodiments.

FIG. 3 illustrates another perspective view of the massaging device, according to some embodiments.

FIGS. 4A, 4B, 4C, and 4D illustrate different configurations of heads of the massaging device, according to some embodiments.

FIG. 5 illustrates a front view of the massaging device, according to some embodiments.

FIG. 6 illustrates a perspective view of the massaging device, according to some embodiments.

FIG. 7 illustrates how the head couples to a mount of the massaging device, according to some embodiments.

FIG. 8 illustrates a perspective view of the base of the massaging device, according to some embodiments.

FIGS. 9 and 10 illustrate the user in a supine position while using the massaging device on the user's neck, according to some embodiments.

FIGS. 11, 12, and 13 illustrate the user in an upright position while using the massaging device on the user's neck, according to some embodiments.

FIG. 14 illustrates the user using the massaging device on their arm, according to some embodiments.

FIG. 15 illustrates the user using the massaging device on their leg, according to some embodiments.

FIG. 16 illustrates the user using the massaging device on their foot, according to some embodiments.

FIG. 17 illustrates segments of the massaging device, according to some embodiments.

FIG. 18 illustrates the massaging device with additional segments, according to some embodiments.

FIG. 19 illustrates a heat element of the massaging device, according to some embodiments.

FIG. 20 illustrates a percussion element of the massaging device, according to some embodiments.

FIG. 21 illustrates a perspective view of a massaging device coupled to a docking station, according to some embodiments.

FIG. 22 illustrates a front view of the massaging device of FIG. 21, according to some embodiments.

FIGS. 23A, 23B, 23C, and 23D illustrate different configurations of heads of the massaging device of FIG. 21, according to some embodiments.

FIG. 24 illustrates a head of the massaging device of FIG. 21, according to some embodiments.

FIGS. 25A and 25B illustrate different configurations of the heads of the massaging device of FIG. 21, according to some embodiments.

FIGS. 26A and 26B illustrate different configurations of the heads of the massaging device of FIG. 21, according to some embodiments.

FIG. 27 illustrates a heat element of the massaging device of FIG. 21, according to some embodiments.

FIG. 28 illustrates a percussion element of the massaging device of FIG. 21, according to some embodiments.

FIG. 29 illustrates a perspective view of a massaging device, according to some embodiments.

### DETAILED DESCRIPTION OF THE INVENTION

Neck pain impacts 30-50% of adults, with 50% to 80% of those people not getting complete resolution from pain. Effective treatment for neck pain in physical therapy usually involves Spinal Manipulation, Therapeutic exercise, Manual Trigger point release, Dry Needling, Cervical Traction, and Manual Massage. Patients may also seek pain relief through medication, steroid shots, and surgery. Despite treatment, over time, neck pain often returns due to many factors such as poor sleep, stress, sports injury, aging, poor posture, and phone and computer use. There is a need for an improved device to provide relief from neck pain, as well as pain in other parts of the body. This disclosure describes a massage device configured to provide trigger point release, thereby providing pain relief.

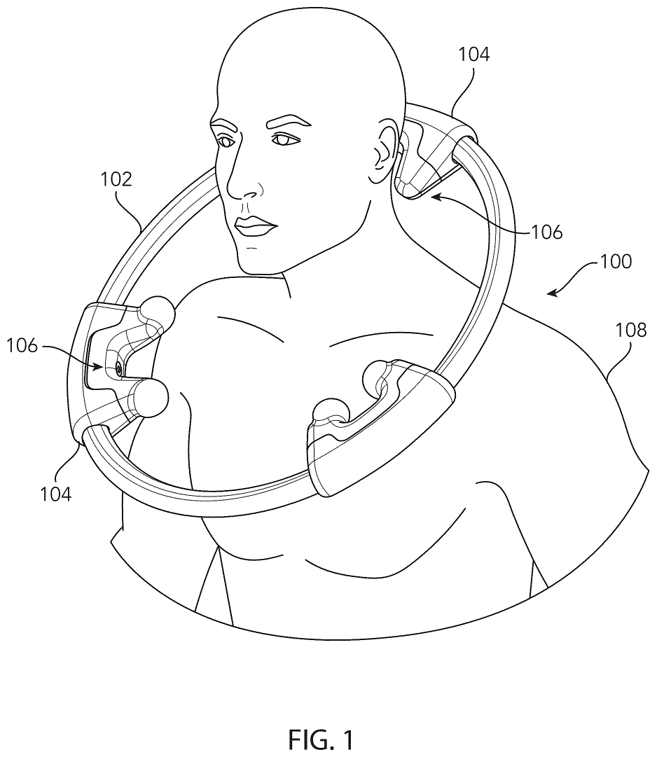

FIG. 1 illustrates a massaging device 100 around the neck of a user 108. In some embodiments, the massaging device 100 includes a housing 102 with at least one mount 104 coupled to and/or disposed about the housing 102. At least one head 106 may be coupled to each mount of the at least one mount 104. In some embodiments, the massaging device 100 is configured such that the user 108 grips the housing 102 (e.g., via the user's hand(s)) and gently manipulates the massaging device 100 such that the at least one head 106 provides pressure to the body of the user 108. The pressure provided by the at least one head 106 may aid in trigger point release to provide pain relief to the user 108. For example, the user 108 may position the massaging device 100 such that at least one head 106 contacts a target area, such as the neck or upper trapezius muscles. The user 108 may then gently pull the housing 102 such that the at least one head 106 presses into the target area to release tension in that area. The user 108 may pull and release multiple times, or even move the housing 102 in a side-to-side rocking motion, to provide deeper massaging pressure. Use of the massaging device 100 on other portions of the body will be described in greater detail later in this disclosure.

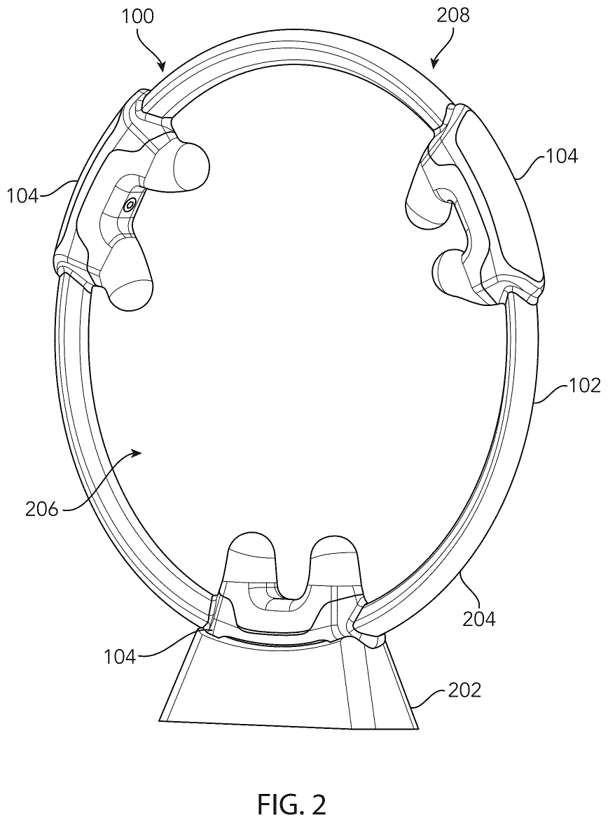

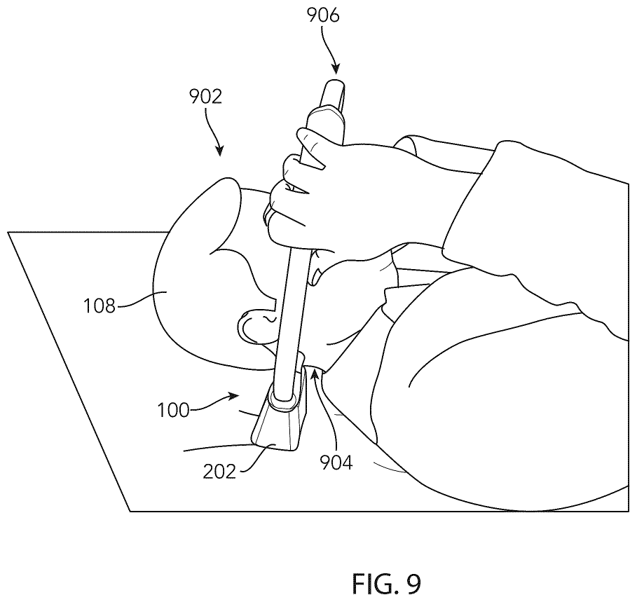

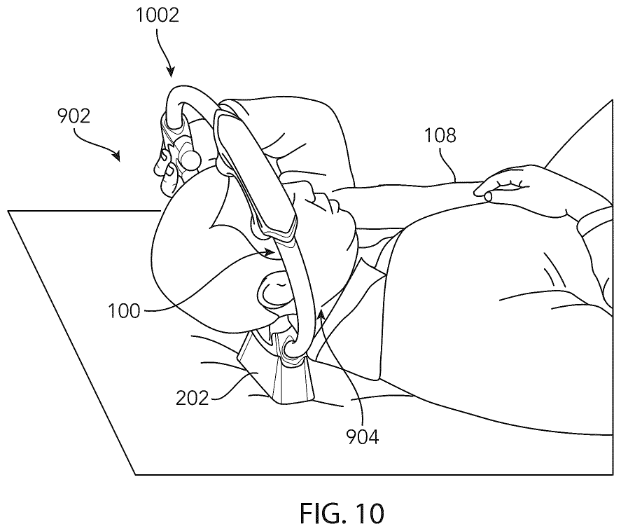

FIG. 2 shows the massaging device 100 coupled to a base 202. In some embodiments, the base 202 is configured to receive the massaging device 100 for storage, keeping the massaging device 100 off a ground surface and out of the way when not in use. The massaging device 100 may be used when coupled to the base 202, as will be discussed in greater detail with reference to FIGS. 9 and 10.

In some embodiments, the housing 102 defines a perimeter 204 and a central open area 206. The central open area 206 may be configured to receive part of the user 108, such as the head of the user 108, as demonstrated in FIG. 1. The at least one mount 104 may be configured to couple to the housing 102 along the perimeter 204. In some embodiments, the at least one mount 104 slideably couples to the perimeter 204, such that the perimeter 204 slides through the at least one mount 104. The at least one mount 104 may be fixedly coupled to the perimeter 204. In some embodiments, the at least one mount 104 is movably coupled along the perimeter 204, such that the user 108 may move the at least one mount 104 along the perimeter 204 to change the position of the at least one mount 104.

FIG. 2 also illustrates that, in some embodiments, the massaging device 100 defines an enclosed shape 208. In some embodiments, the enclosed shape 208 defines a substantially circular, or ring, shape, as shown in FIG. 2. The ring shape may provide leverage for the user 108 to apply pressure to a target area when using the massaging device 100. Further, the ring shape may allow the user 108 to change angles of the massaging device 100, for example, by rotating the massaging device 100, providing an arc of pressure that aligns with the arc of the human body. This means the angle of pressure can have an effective treatment arc to cover the upper C0-C1 levels of the neck down to the C7-T1 levels of the neck.

It should be noted, however, that the shape of the massaging device 100 is not limited to a substantially circular, or ring, shape. In some embodiments, the massaging device 100 defines an oblong or ovoid shape, rather than a circular shape. The massaging device 100 may define an irregular, or asymmetrical, shape. In some embodiments, the massaging device 100 defines a rectangular shape. The massaging device 100 may define a triangular shape. The massaging device 100 may define any shape suitable to receive a portion of a user's body and/or provide massaging pressure thereto.

In addition, the massaging device 100 is not limited to defining the enclosed shape 208. In some embodiments, the massaging device 100 includes an opening along the perimeter 204 to allow the user 108 to access the central open area 206. For example, the massaging device 100 may be sized to fit around the waist of the user 108. Rather than fitting the massaging device 100 over the shoulders or hips of the user 108 to reach the waist, the massaging device 100 may include an opening in the perimeter 204 to allow the user 108 to position the massaging device 100 around their waist. Accordingly, the massaging device 100 may be made of a material or combination of materials with some flex, so as to provide a degree of flexibility, while still being rigid enough to provide sufficient pressure to the user 108.

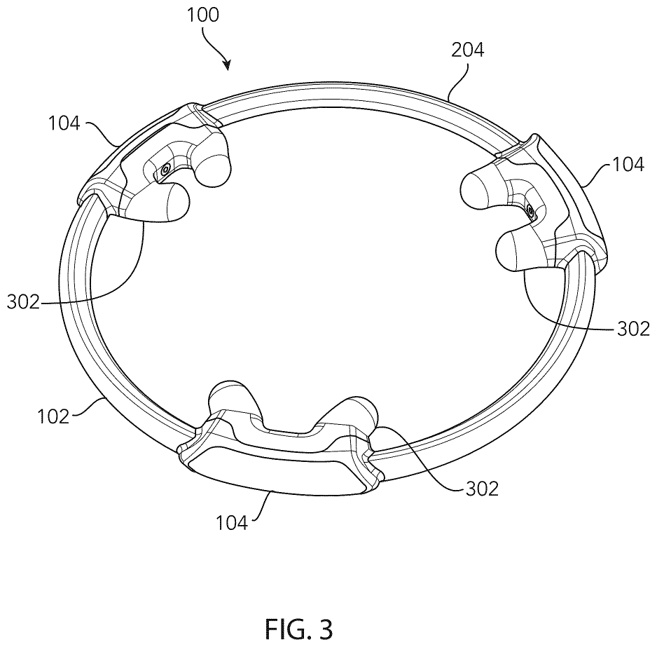

FIG. 3 illustrates another perspective view of the massaging device 100. In some embodiments, the at least one head 106 includes a plurality of heads, wherein each head of the plurality of heads are shown with reference character 302 in FIG. 3. Each head 302 of the plurality of heads may be coupled to a mount of the at least one mount 104. The plurality of heads may be spaced along the perimeter 204 of the housing 102. For example, each head 302 may be coupled to a corresponding mount of a plurality of mounts 104 that are spaced along the perimeter 204, as described herein. In some embodiments, the plurality of heads 302 is spaced substantially equidistant along the perimeter 204 so as to be configured to provide substantially symmetrical pressure about the body of the user 108. The plurality of heads 302 may be spaced non-equidistant from one another. For example, two of the plurality of heads 302 may be located closer to one another than shown in FIG. 3 to provide massaging treatment to two target areas, such as both sides of the upper trapezius muscles, at substantially the same time.

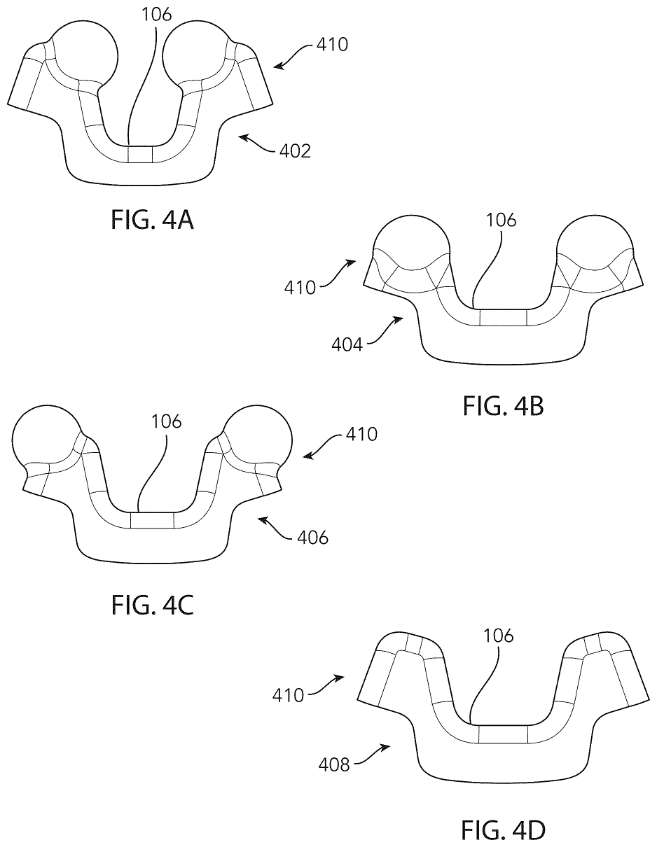

In some embodiments, the at least one head 106 includes a therapeutic portion 410 configured to define different configurations, as illustrated in FIGS. 4A, 4B, 4C, and 4D. The different configurations may include a first configuration 402, as shown in FIG. 4A, a second configuration 404, as shown in FIG. 4B, a third configuration 406, as shown in FIG. 4C, and/or a fourth configuration 408, as shown in FIG. 4D. The different configurations may be sized to accommodate different portions of a user's 108 body, and/or users 108 of different body sizes. For example, when the massaging device 100 is used to provide a neck massage, a child may have a smaller neck than an adult, and therefore may need a head 106 with a narrower configuration of the therapeutic portion 410. In addition, a user 108 desiring to use the massaging device 100 on different parts of their body may need different configurations depending on the treatment area.

In some embodiments, the first configuration 402 is configured to correspond to a first portion of the body of the user 108 and provide massaging pressure to the first portion. Alternatively or additionally, the first configuration 402 may also correspond to a user 108 of a first body size. For example, the therapeutic portion 410 in the first configuration 402 may correspond to a narrow treatment area and/or a smaller user 108.

In some embodiments, the second configuration 404 is configured to correspond to a second portion of the body of the user 108 and provide massaging pressure to the second portion. In some embodiments, the second portion is wider than the first portion. Alternatively or additionally, the second configuration 404 may correspond to a user 108 of a second body size, which may be larger than the first body size. In some embodiments, the therapeutic portion 410 in the second configuration 404 corresponds to a medium-sized treatment area and/or a medium-sized user 108.

In some embodiments, the third configuration 406 is configured to correspond to a third portion of the body of the user 108 and provide massaging pressure to the third portion. In some embodiments, the third portion is wider than the first portion and the second portion. Alternatively or additionally, the third configuration 406 may correspond to a user 108 of a third body size, which may be larger than the first body size and the second body size. In some embodiments, the therapeutic portion 410 in the third configuration 406 corresponds to a wide treatment area and/or a larger-size user 108.

In some embodiments, the fourth configuration 408 is configured to correspond to a fourth portion of the body of the user 108 and provide massaging pressure to the fourth portion. In some embodiments, the fourth portion is similar in size to the second portion. Alternatively or additionally, the fourth configuration 408 may correspond to a user 108 of a fourth body size. In some embodiments, the therapeutic portion 410 in the fourth configuration 408 corresponds to a medium-sized treatment area and/or a medium-sized user 108. The fourth configuration 408 may also lack the rounded elements shown in the first, second, and third configurations 402, 404, 406 to provide a different massage sensation to the user 108.

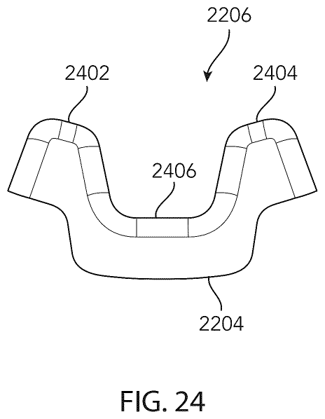

All the embodiments shown in the accompanying figures are intended as non-limiting examples, and show only a few possible configurations for the therapeutic portion 410 of the at least one head 106. The therapeutic portion 410 may include a completely different design from what is specifically shown in the figures. In addition, the therapeutic portion 410 may be custom-designed for the needs and anatomy of a particular user 108. In some embodiments, the therapeutic portion 410 of the at least one head 106 includes at least one treatment element, as will be discussed in greater detail with reference to FIGS. 24, 25A, 25B, 26A, and 26B.

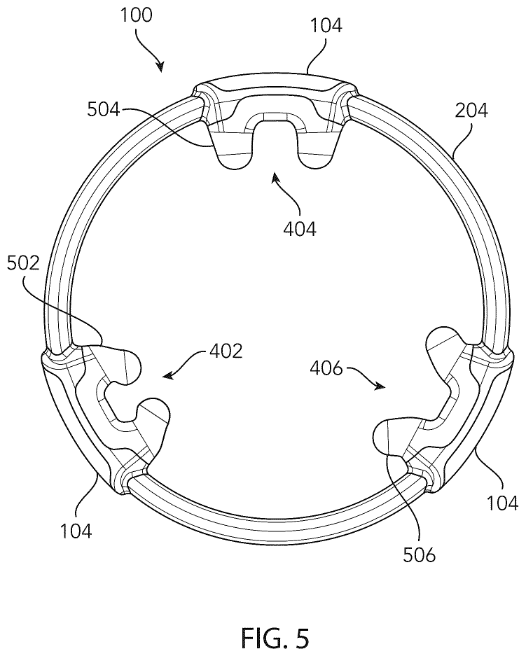

FIG. 5 shows the massaging device 100, including a first head 502 having the first configuration 402, a second head 504 having the second configuration 404, and a third head 506 having the third configuration 406. In some embodiments, each of the first head 502, the second head 504, and the third head 506 are configured to be interchangeably coupled to any of the three mounts 104 depicted in FIG. 5. Stated differently, each mount of the at least one mount 104 may define substantially the same form factor so as to be interchangeably coupled to any head of the at least one head 106. Further, each of the first head 502, the second head 504, and the third head 506 may be removably coupled to any one mount of the at least one mount 104, so that the at least one head 106 at a given location (corresponding to a respective mount) can be swapped out for a different configuration. For example, the second head 504 may be removed from the corresponding mount 104 depicted in FIG. 5 and replaced with a different head defining the fourth configuration 408 shown in FIG. 4D.

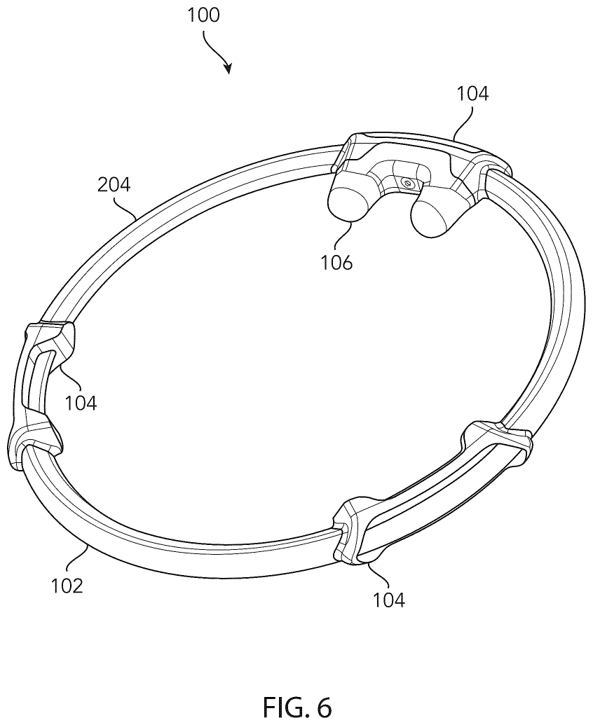

FIG. 6 shows the massaging device 100 with one head 106 coupled to a mount 104, while two other mounts 104 are shown as not being coupled to a head 106. Accordingly, the user 108 may selectively attach and/or remove one or more heads 106 from the massaging device (e.g., with respect to a mount 104) when not in use. For example, in an embodiment where each mount of the at least one mount 104 is equally spaced from the others, the user 108 may remove one or more of heads 106 from a corresponding mount 104 to provide a better grip area along the perimeter 204 of the housing 102, such that the user 108 may grip (e.g., via the user's hand(s)) the “unoccupied” mount(s) 104 and enable the application of substantially symmetrical pressure on the remaining at least one head 106.

In some embodiments, the at least one mount 104 is movably coupled along the perimeter 204 of the housing 102. The at least one mount 104 may be configured to slideably receive the perimeter 204 through at least one opening of the at least one mount 104. Accordingly, the housing 102 may, at some point during manufacturing, include an end configured to be fed through the at least one mount 104 before the massaging device 100 is formed into the previously-discussed enclosed shape 208. In some embodiments, the at least one mount 104 is configured to open and clasp (i.e., fasten, close, clamp, or the like) at least partially around a portion of the perimeter 204. As such, the at least one mount 104 may be removable from the housing 102. It should be noted that the massaging device 100 is not limited to exactly three mounts of the at least one mount 104. In some embodiments, the massaging device 100 includes fewer than three mounts. The massaging device 100 may include more than three mounts.

The at least one mount 104 may be fixedly coupled along the perimeter 204. In some embodiments, the at least one mount 104 is formed on the perimeter 204 during the manufacturing process, for example by injection molding, such that the at least one mount 104 is an immovable part of the housing 102, rather than a separate component. The at least one mount 104 may be a separate component fixedly coupled to the housing 102, such as via adhesive, friction fit, and/or one or more mechanical fasteners.

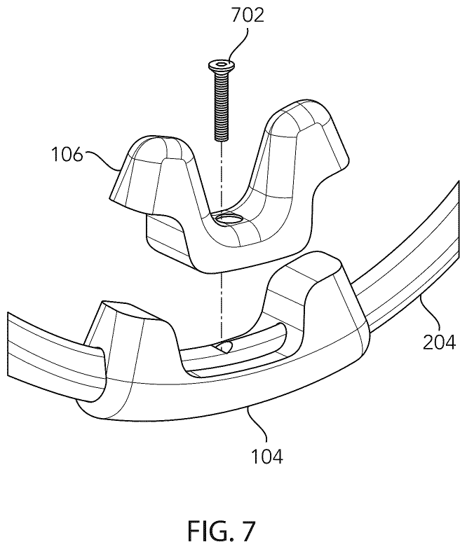

As previously stated, the at least one head 106 may be removably coupled to the at least one mount 104. As shown in FIG. 7, the shape of the at least one head 106 may be complementary to the shape of the at least one mount 104, such that the at least one mount 104 is configured to receive at least a portion of the at least one head 106. For example, the at least one mount 104 may include a recessed surface or area configured to receive and couple to at least a portion of the at least one head 106. It should be noted, however, that the at least one mount 104 and the at least one head 106 are not limited to the specific shapes shown in the accompanying figures.

In some embodiments, the at least one head 106 is coupled to the at least one mount 104 via at least one attachment mechanism 702, as demonstrated in FIG. 7. The attachment mechanism 702 may include, but is not limited to, one or more of the following: a threaded fastener, such as a screw; a button; hook-and-loop fastener; a snap; a tab; and a magnet. In some embodiments, the at least one head 106 is coupled to the at least one mount 104 via a friction fit. The at least one head 106 may be coupled to the at least one mount 104 via a mechanism, such as one or more tabs, with a quick release option to facilitate easy application and/or removal of the at least one head 106. In some embodiments, the at least one head 106 is configured to also couple to at least a portion of the perimeter 204 of the housing 102, in addition to or independently from the at least one mount 104.

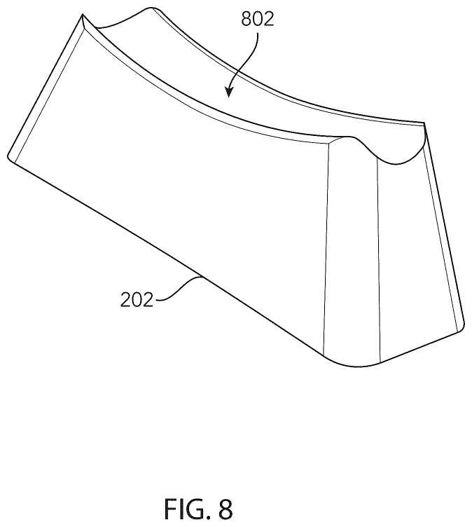

FIG. 8 illustrates the base 202 first shown in FIG. 2. As previously stated, the base 202 may be configured to couple to the massaging device 100 for storage and/or use. In some embodiments, the base 202 includes a cradle 802 configured to receive at least a portion of the housing 102 and/or at least a portion of the at least one mount 104. The cradle 802 may define a curved shape complementary to that of an outward portion the at least one mount 104 such that the at least one mount 104 may rest in the cradle 802, as illustrated in FIG. 2. As described here, “outward portion,” may be understood as the portion of the at least one mount 104 opposite that where the at least one head 106 is coupled, or the portion furthest from the central open area 206 of the massaging device 100 when the at least one mount is coupled to the housing 102. In some embodiments, the perimeter 204 of the housing 102 is configured to couple to the base 202. The perimeter 204 and/or at least one mount 104 may securably couple to the base 202 via a friction fit, magnetic coupling, and/or any other suitable manner.

FIG. 9 shows the user 108 in a supine position 902 while using the massaging device 100 to massage their neck 904. In some embodiments, the massaging device 100 is configured to be used while coupled to the base 202, as demonstrated in FIG. 9. Using the massaging device 100 this way may help the user 108 achieve spinal decompression, because the support of the base 202 provides additional leverage to increase the space between the cervical spine segments. Accordingly, using the massaging device 100 while the device 100 is coupled to the base 202 may also help the user 108 achieve cervical traction. The massaging device 100 may also be used against a floor surface, rather than the base 202, when the user 108 is in the supine position 902.

FIG. 9 also shows the massaging device 100 at a first angle 906. In some embodiments, the position of the massaging device 100 at the first angle 906 is substantially perpendicular to a floor surface, and at least a portion of the massaging device 100 is located over a middle portion of the user's 108 face, such as near the nose. The user 108 may manipulate the massaging device 100 to change the angle. For example, as shown in FIG. 10, the user 108 may move the massaging device 100 to a second angle 1002, where at least a portion of the massaging device 100 is located over the user's 108 forehead and/or hairline area, rather than their nose. The massaging device 100 may also be tilted in the opposite direction, toward the chin and chest of the user 108.

In some embodiments, changing the position and/or angle of the massaging device 100 changes the angle of the therapeutic portion 410 of the at least one head 106 (e.g., an angle of the therapeutic portion 410 relative to a target body portion of the user, such as the neck), thereby altering the massaging pressure experienced by the user 108. For example, the user 108 may manipulate the massaging device 100 back and forth between the first angle 906 and the second angle 1002 to create a more dynamic massage experience. This movement may help “work out” any particularly sore areas, or “knots” in the neck 904 of the user 108. The user 108 may also rotate the massaging device 100 to achieve side-to-side massaging pressure.

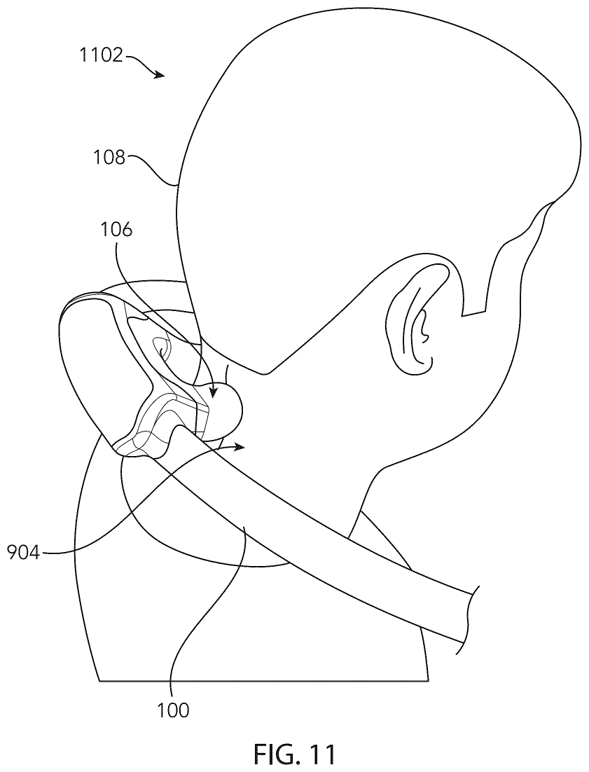

FIG. 11 illustrates the user 108 in an upright position 1102, rather than the supine position 902. In some embodiments, the “upright” position 1102 includes standing, kneeling, seated, and/or reclined positions. The user 108 may be configured to use the massaging device 100 while in the upright position 1102 to provide massaging pressure to a number of treatment areas, including the neck 904. Compared to the supine position 902, where the pressure of the at least one head 106 against the user 108 was provided by a combination of gravity and the weight of the user 108 pressing into the at least one head 106, in the upright position 1102, the user 108 applies pressure by manipulating (i.e., pulling on) the massaging device 100.

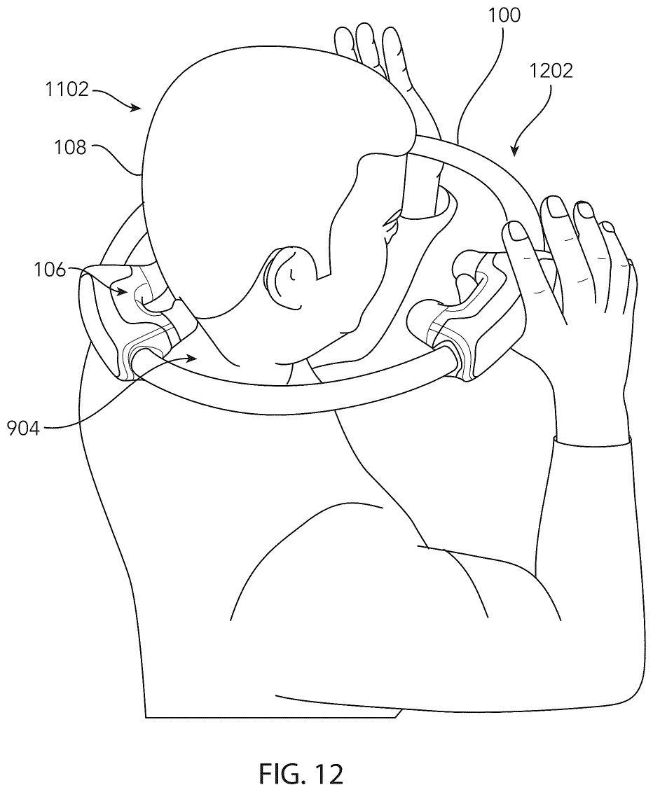

For example, as shown in FIG. 12, the user 108 may grasp and pull on the massaging device 100 to gently press the at least one head 106 into their neck 904. As with the supine position 902, in the upright position 1102, the user 108 may change the angle of the massaging device 100 to change how they experience the massaging pressure. For example, FIG. 12 demonstrates the massaging device 100 at a first angle 1202, with the massaging device substantially parallel with the shoulders of the user 108, if not tilted slightly upward toward the forehead of the user 108.

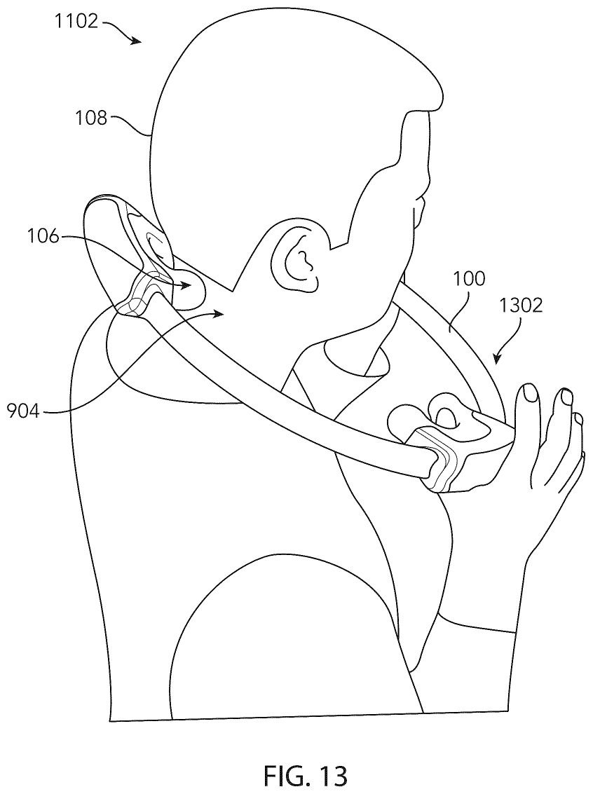

In comparison, FIG. 13 illustrates the massaging device 100 at a second angle 1302, where the massaging device 100 is tilted downward toward the chest of the user 108. The user 108 may manipulate the massaging device 100 back and forth between the first angle 1202 and the second angle 1302 to create a more dynamic massage experience. This movement may help “work out” any particularly sore areas, or “knots” in the neck 904 of the user 108. The user 108 may also rotate the massaging device 100 to achieve side-to-side massaging pressure.

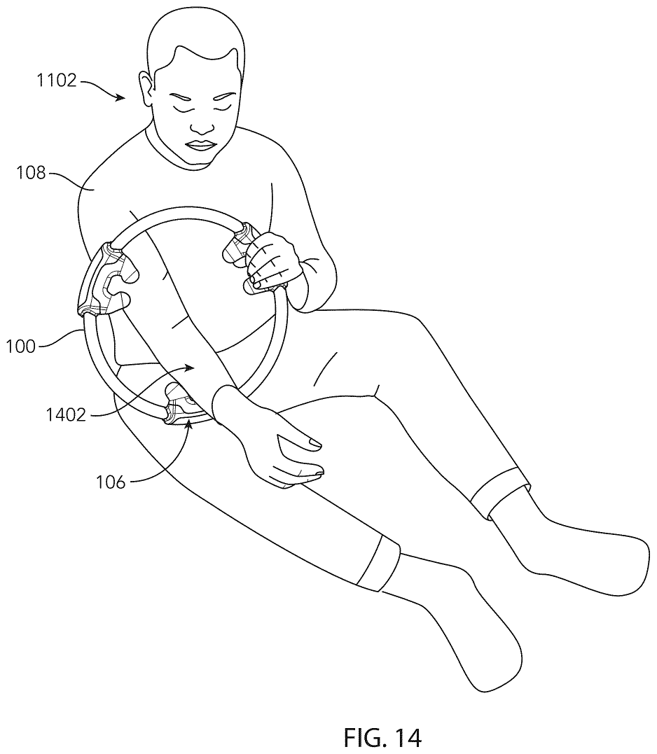

While the disclosure thus far has focused on using the massaging device 100 on the neck 904 of a user 108, FIGS. 14-16 show that the massaging device 100 may be used on other portions of the body. For example, as shown in FIG. 14, the user 108 may engage the massaging device 100 to provide massaging pressure to their arm 1402, such as the forearm. The massaging device 100 may also be used on the shoulder(s), bicep(s), tricep(s), wrist(s), and/or even hand(s) of the user 108. When using the massaging device 100 on their arm 1402, the user 108 may rest their arm 1402 on a surface such as a tabletop, counter, cushion, or leg, as shown in FIG. 14. The user 108 may also choose to not rest their arm 1402 on any surface while using the massaging device 100. The user 108 may opt to use any of the first configuration 402, the second configuration 404, the third configuration 406, or the fourth configuration 408 when massaging any portion of their arm 1402.

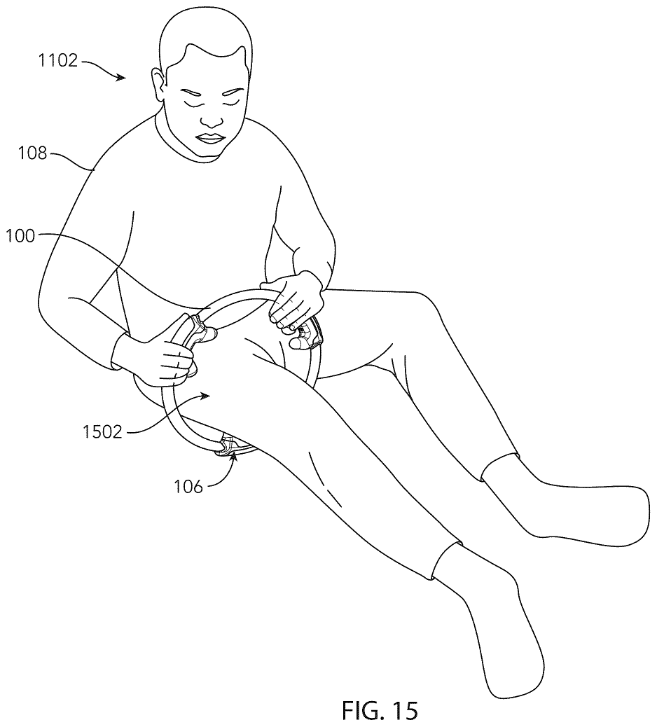

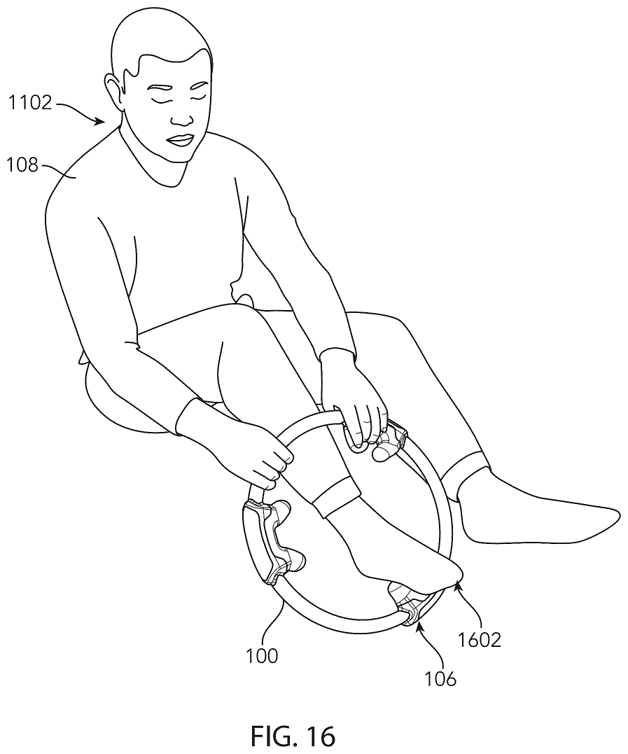

FIG. 15 shows the user 108 using the massaging device on their leg 1502. The massaging device 100 may be used on any portion of the leg 1502, such as the hamstring (as demonstrated in FIG. 15), inner and/or outer thigh areas, the quadriceps, around the knee, the calf, the shin, the ankle, and/or even on the foot 1602, as illustrated in FIG. 16. When using the massaging device 100 on their leg 1502 or foot 1602, the user 108 may rest their leg 1502 or foot 1602 on a surface such as the floor, a couch, or a bed. The user 108 may also choose to not rest their leg 1502 or foot 1602 on any surface while using the massaging device 100. The user 108 may opt to use any of the first configuration 402, the second configuration 404, the third configuration 406, or the fourth configuration 408 when massaging any portion of their leg 1502 or foot 1602.

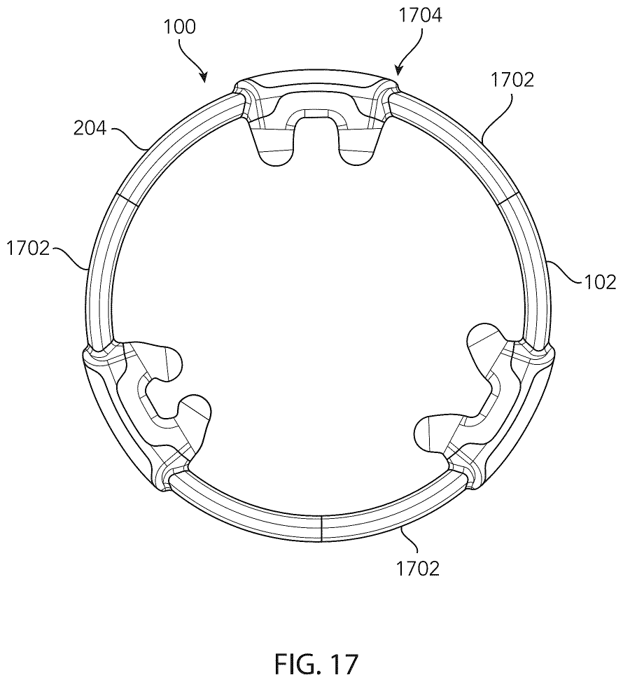

FIG. 17 illustrates that, in some embodiments, the housing 102 of the massaging device 100 includes a plurality of segments 1702. The plurality of segments 1702 may be mechanically coupled together to form the perimeter 204 of the housing 102. For example, the plurality of segments 1702 may be configured to snap together via a friction fit, where one end of one segment of the plurality of segments 1702 receives at least a portion of an adjacent end of another segment of the plurality of segments 1702. In some embodiments, the plurality of segments 1702 couple together via magnetic coupling, threaded coupling, or the like. The plurality of segments 1702 may be configured to couple together via any number of suitable methods not explicitly described in this disclosure.

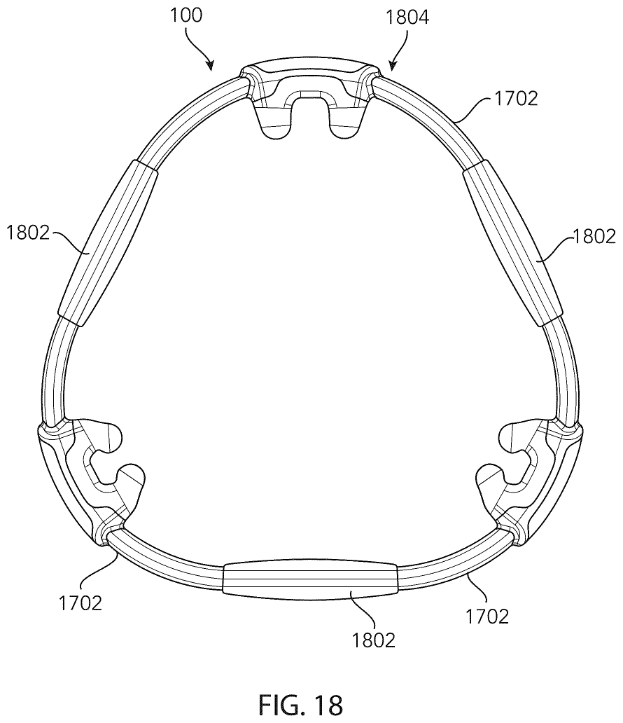

FIG. 18 shows that, in some embodiments, the plurality of segments 1702 is removably coupled together, such that at least one segment 1802 can be added and/or removed from the plurality of segments 1702 to change the size of the massaging device 100. For example, FIG. 17 demonstrates a first size 1704 of the massaging device 100, while FIG. 18 demonstrates a second size 1804, which, with the addition of at least one segment 1802, may be larger than the first size 1704. In some embodiments, each of the at least one segment 1802 added to the plurality of segments 1702 defines a substantially straight shape, rather than a curved shape. Accordingly, the overall shape, in addition to the size, of the massaging device 100 may change with the addition of at least one segment 1802.

The second size 1804 may be configured to fit over the shoulders and/or hips of the user 108 to enable the massaging device 100 to fit around the user's 108 midsection and provide massaging pressure to their back, abdomen, and/or chest. Of course, more than three additional segments may be added to the plurality of segments 1702 to even further increase the size of the massaging device 100. In some embodiments, only one or two additional segments is added to the plurality of segments 1702, to result in a massaging device defining a size between the first size 1704 and the second size 1804. In some embodiments, one or more of the plurality of segments 1702 is configured to be removed to decrease the size of the massaging device 100 such that it becomes smaller than the first size 1704. Alternatively or additionally, removing one or more of the plurality of the segments 1702 may alter the massaging device to include an opening along the perimeter 204.

The at least one mount 104 and the at least one head 106 may be configured to couple to any of the plurality of segments 1702 and the at least one segment 1802. A user 108 may add at least one segment 1802 to the plurality of segments 1702 to create extra space for additional mount(s) of the at least one mount 104 and additional head(s) of the at least one head 106. The segmented nature of the housing 102 may also be desirable for storage and/or traveling purposes. For example, the user 108 may be able to removably couple the plurality of segments 1702 from one another to more easily pack the massaging device 100 in a suitcase, or even a small backpack.

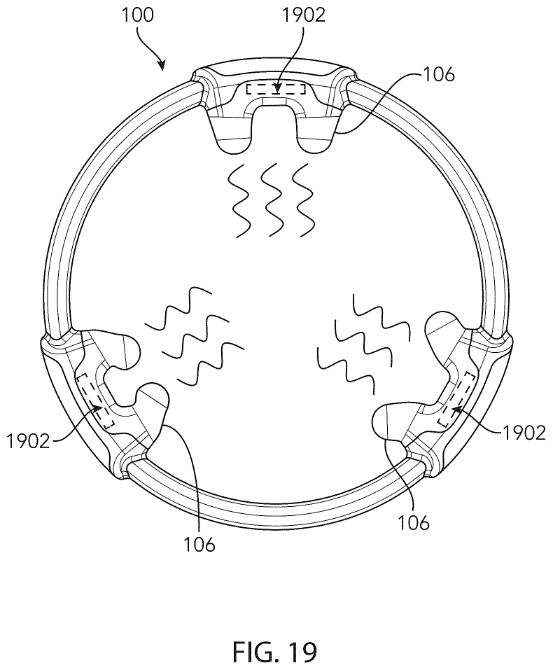

FIG. 19 illustrates that, in some embodiments, the massaging device 100 includes a heat element 1902. The heat element 1902 may be electrically coupled to the massaging device 100 and configured to warm the at least one head 106 such that when the at least one head 106 contacts the user 108, the user 108 feels the warmth along with the massaging pressure from the at least one head 106. Accordingly, the massaging device 100 may be configured to provide heat therapy via the heat element 1902.

In some embodiments, as indicated in FIG. 19, the heat element 1902 is located within the at least one head 106. The heat element 1902 may be located elsewhere on and/or in the massaging device 100, such as within the housing 102 and/or the at least one mount 104. In some embodiments, the heat element 1902 is located within the base 202 and is configured to transfer heat to the housing 102, including the at least one head 106. The base 202 may be configured to provide power to (i.e., “charge”) the heat element 1902 located on and/or in the housing 102. At least one of the base 202 and the housing 102 may be powered via battery power. At least one of the base 202 and the housing 102 may be powered via a hardwired power supply, such as a wall outlet or other external power source. In some embodiments, the heat element 1902 is adjustable to allow the user 108 to control the amount of heat emitted by, for example, the at least one head 106.

In addition to emitting heat, the at least one head 106 may be configured to emit a cold sensation upon contact with the user 108. For example, the massaging device 100 may include a cold element similar to the heat element 1902, where the cold element may be configured to chill the at least one head 106 and thereby provide cold therapy to the user 108. In some embodiments, the user 108 may store the at least one head 106 in a cold environment, such as a refrigerator or freezer, so that the at least one head 106 is kept cold prior to use.

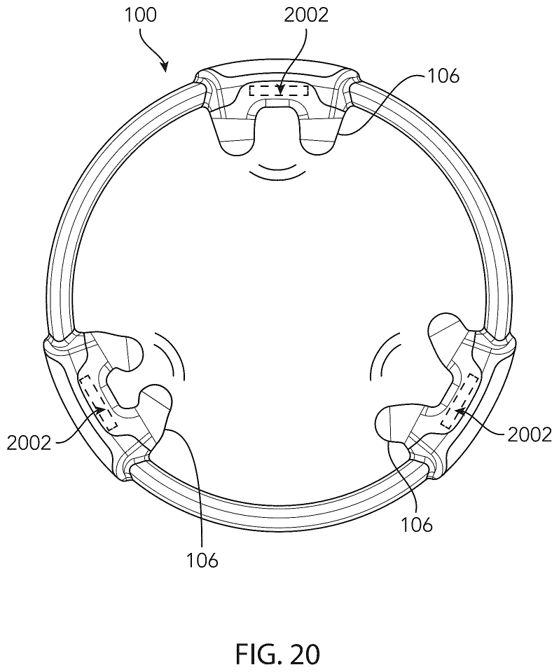

FIG. 20 illustrates that, in some embodiments, the massaging device 100 includes a percussion element 2002. The percussion element 2002 may be electrically coupled to the massaging device 100 and configured to agitate (e.g., vibrate, shake, pulsate, palpitate, and the like) the at least one head 106 such that when the at least one head 106 contacts the user 108, the user 108 feels the agitation along with the massaging pressure from the at least one head 106. Accordingly, the massaging device 100 may be configured to provide percussion therapy via the percussion element 2002. The addition of percussion therapy may allow the user 108 to experience a deeper massage.

In some embodiments, as indicated in FIG. 20, the percussion element 2002 is located within the at least one head 106. The percussion element 2002 may be located elsewhere on and/or in the massaging device 100, such as within the housing 102 and/or the at least one mount 104. In some embodiments, the percussion element 2002 is located within the base 202. The base 202 may be configured to provide power to (i.e., “charge”) the percussion element 2002 located on and/or in the housing 102. At least one of the base 202 and the housing 102 may be powered via battery power. At least one of the base 202 and the housing 102 may be powered via a hardwired power supply, such as a wall outlet or other external power source. In some embodiments, the percussion element 2002 is adjustable to allow the user 108 to control the amount of agitation produced by the at least one head 106. The percussion element 2002 may include a motor configured to produce the vibration/agitation of the at least one head 106.

The massaging device 100 may include one or both of the heat element 1902 and the percussion element 2002. It should be noted that the massaging device 100 may include means to remotely control any powered component of the massaging device 100, including the heat element 1902 and the percussion element 2002. For example, the massaging device 100 may include a control panel, a timer, a remote control, an application on a smartphone or tablet, and/or the like, to operate the heat element 1902 and/or the percussion element 2002. Elements other than the heat element 1902 and the percussion element 2002 may be operable by a remote device.

In some embodiments, the massaging device 100 includes at least one washable cover configured to fit over the at least one head 106 to preserve the cleanliness of the at least one head 106. For example, when used by multiple people, such as in a clinic setting, it may be desirable to use a barrier to prevent direct contact between each user 108 and the at least one head 106. An individual user 108 and private owner of the massaging device 100 may also use a cover to prevent any oil, sweat, or the like from contacting the at least one head 106. The cover may also provide additional traction when using the massaging device 100. The cover may be made of fabric such as cotton or a polymer material, such as silicone. In addition, the at least one head 106 may be made of a material that is easy to clean with common cleaners, such as antiseptic wipes.

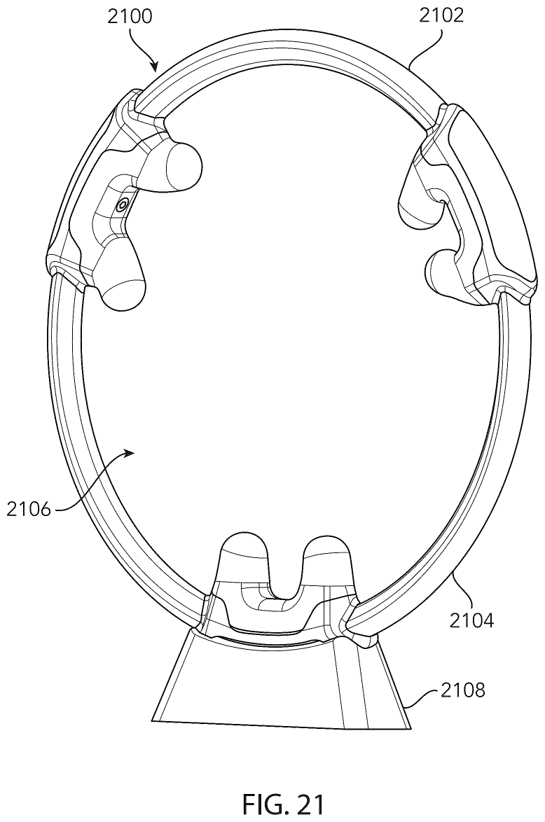

FIG. 21 illustrates a massaging device 2100. In some embodiments, the massaging device 2100 is substantially similar to the massaging device 100. For example, the massaging device 2100 may include a ring 2102 defining a perimeter 2104 and a central open area 2106, which may be substantially similar to the housing 102, perimeter 204, and central open area 206 of the massaging device 100. The massaging device 2100 may also include a docking station 2108 substantially similar to the base 202 of the massaging device 100.

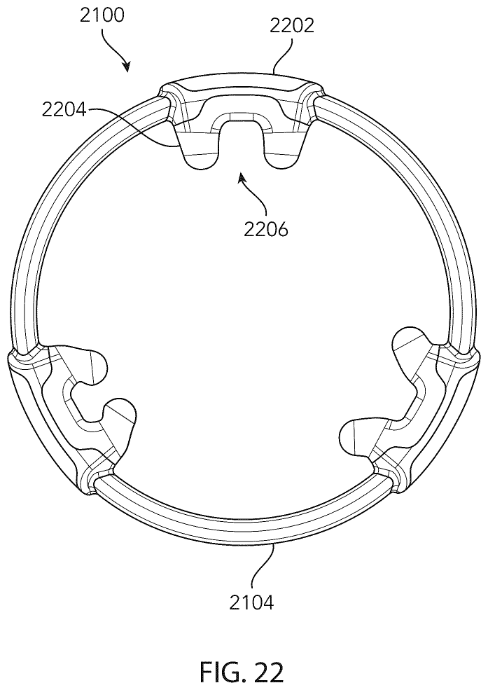

In some embodiments, as shown in FIG. 22, the massaging device 2100 includes a mount 2202 located along the perimeter 2104 of the ring 2102. The massaging device 2100 may also include a head 2204 coupled to the mount 2202. The mount 2202 may be substantially similar to the at least one mount 104 of the massaging device 100, and the head 2204 may be substantially similar to the at least one head 106 of the massaging device 100. In some embodiments, the head 2204 is detachably coupled to the mount 2202 in a manner similar to that discussed with reference to the at least one mount 104 and at least one head 106 shown in FIG. 7. The head 2204 may include a therapeutic portion 2206, as indicated in FIG. 22.

In some embodiments, the massaging device 2100 is configured such that the user 108 grips the ring 2102 and gently manipulates the massaging device 2100 such that the therapeutic portion 2206 of the head 2204 provides pressure to the body of the user 108. The pressure provided by head 2204 may aid in trigger point release to provide pain relief to the user 108. For example, the user 108 may position the massaging device 2100 such that the head 2204 contacts a target area, such as the neck, upper trapezius muscles, leg, arm, or the like. The user 108 may then gently pull the ring 2102 such that the therapeutic portion 2206 of the head 2204 presses into the target area to release tension in that area. The user 108 may pull and release multiple times, or even move the ring 2102 in a side-to-side rocking motion, to provide deeper massaging pressure. As discussed above for the massaging device 100, the massaging device 2100 may be used virtually anywhere on the body of the user 108, as shown in particular with reference to FIGS. 9-16.

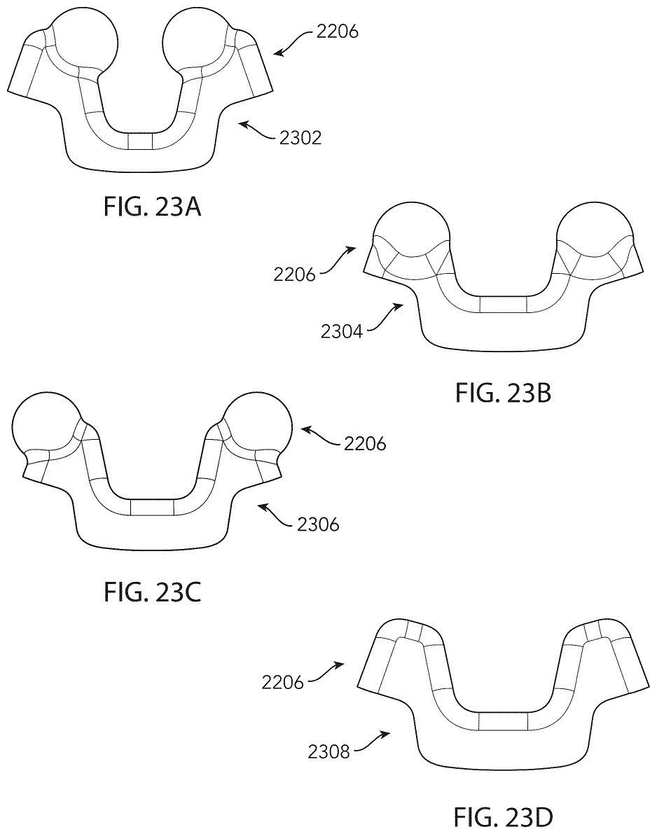

In some embodiments, the therapeutic portion 2206 of the head 2204 defines different configurations, as illustrated in FIGS. 23A, 23B, 23C, and 23D. The different configurations may include a first configuration 2302, as shown in FIG. 23A, a second configuration 2304, as shown in FIG. 23B, a third configuration 2306, as shown in FIG. 23C, and a fourth configuration 2308, as shown in FIG. 23D. The different configurations may be sized to accommodate different portions of a user's 108 body, and/or users 108 of different body sizes. For example, when the massaging device 2100 is used to provide a neck massage, a child may have a smaller neck than an adult, and therefore may need a head 2204 with a narrower configuration of the therapeutic portion 2206. In addition, a user 108 desiring to use the massaging device 2100 on different parts of their body may need different configurations depending on the treatment area.

In some embodiments, the first configuration 2302 is configured to correspond to a first portion of the body of the user 108 and provide massaging pressure to the first portion. Alternatively or additionally, the first configuration 2302 may also correspond to a user 108 of a first body size. For example, the therapeutic portion 2206 in the first configuration 2302 may correspond to a narrow treatment area and/or a smaller user 108.

In some embodiments, the second configuration 2304 is configured to correspond to a second portion of the body of the user 108 and provide massaging pressure to the second portion. In some embodiments, the second portion is wider than the first portion. Alternatively or additionally, the second configuration 2304 may also correspond to a user 108 of a second body size, which may be larger than the first body size. In some embodiments, the therapeutic portion 2206 in the second configuration 2304 corresponds to a medium-sized treatment area and/or a medium-sized user 108.

In some embodiments, the third configuration 2306 is configured to correspond to a third portion of the body of the user 108 and provide massaging pressure to the third portion. In some embodiments, the third portion is wider than the first portion and the second portion. Alternatively or additionally, the third configuration 2306 may also correspond to a user 108 of a third body size, which may be larger than the first body size and the second body size. In some embodiments, the therapeutic portion 2206 in the third configuration 2306 corresponds to a wide treatment area and/or a larger-size user 108.

In some embodiments, the fourth configuration 2308 is configured to correspond to a fourth portion of the body of the user 108 and provide massaging pressure to the fourth portion. In some embodiments, the fourth portion is similar in size to the second portion. Alternatively or additionally, the fourth configuration 2308 may also correspond to a user 108 of a fourth body size. In some embodiments, the therapeutic portion 2206 in the fourth configuration 2308 corresponds to a medium-sized treatment area and/or a medium-sized user 108. The fourth configuration 2308 may also lack the rounded elements shown in the first, second, and third configurations 2302, 2304, 2306 to provide a different massage sensation to the user 108.

In some embodiments, as shown in FIG. 24, the therapeutic portion 2206 of the head 2204 includes a first raised portion 2402, a second raised portion 2404, and a middle area 2406 located therebetween. The first raised portion 2402 and the second raised portion 2404 may be configured to provide pressure to the body of the user 108. In some embodiments, the middle area 2406 is configured to receive a portion of the user's 108 body while the first raised portion 2402 and the second raised portion 2404 provide massaging pressure to the user 108. In other embodiments, the middle area 2406 may not receive a portion of the user's body, where contact is primarily via the first and second raised portions 2402.

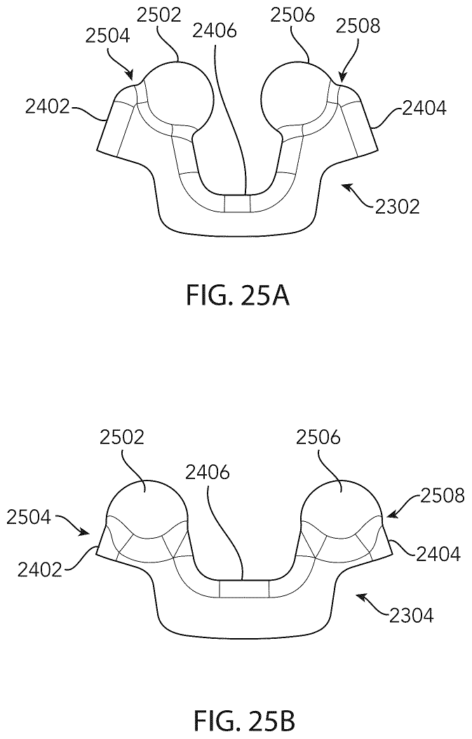

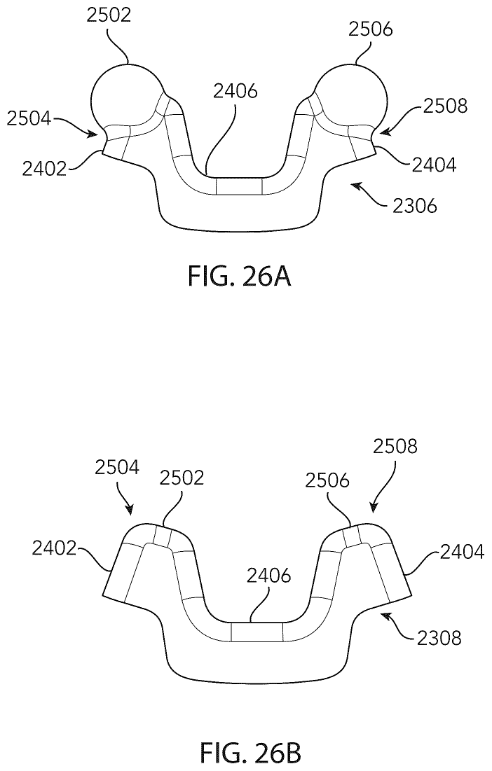

FIGS. 25A, 25B, and 26A illustrate that, in some embodiments, the first raised portion 2402 includes a first treatment element 2502 and the second raised portion 2404 includes a second treatment element 2506. The first treatment element 2502 may be integrated into an end 2504 of the first raised portion 2402. In some embodiments, the first treatment element 2502 is removably coupled to the end 2504 of the first raised portion 2402. The second treatment element 2506 may be integrated into an end 2508 of the second raised portion 2404. In some embodiments, the second treatment element 2506 is removably coupled to the end 2508 of the second raised portion 2404.

As shown in FIG. 25A, in the first configuration 2302, the first treatment element 2502 and the second treatment element 2506 may be angled, or tilted, toward the middle area 2406 of the therapeutic portion 2206. FIG. 25B shows that, in the second configuration 2304, the first treatment element 2502 and the second treatment element 2506 may be pointed toward the central open area 2106 of the ring 2102 when coupled with the ring 2102, rather than toward the middle area 2406 of the therapeutic portion 2206. FIG. 26A shows that, in the third configuration 2306, the first treatment element 2502 and the second treatment element 2506 may be angled, or tilted, away from the middle area 2406 of the therapeutic portion 2206.

In some embodiments, the first treatment element 2502 and the second treatment element 2506 are configured to move independent of the head 2204, and independently with respect to each other. For example, in the embodiments shown in FIGS. 25A, 25B, and 26A, the first and second treatment elements 2502, 2506 are depicted as orbs, and may be configured to move in a circular motion against the treatment area of the user 108. In some embodiments, the first and second treatment elements 2502, 2506 are configured to extend and retract from the head 2204 such that they provide deep percussion therapy, similar to a massage gun. Independently movable treatment elements may be powered via battery power. Independently movable treatment elements may be powered via a hardwired power supply, such as a wall outlet or other external power source. In some embodiments, movement of the first and/or second treatment elements 2502, 2506 are adjustable to allow the user 108 to control the speed, intensity, and type of movement produced by the first and/or second treatment elements 2502, 2506. Further, the user 108 may be able to manually move the first treatment element 2502 and/or the second treatment element 2506 to change the configuration of the therapeutic portion 2206.

It should be noted that the first and second treatment elements 2502, 2506 may define form factors other than the orbs shown in FIGS. 25A, 25B, and 26A. For example, FIG. 26B shows that the first treatment element 2502 and the second treatment element 2506 may define flat, paddle-like elements, rather than rounded orbs. In addition, the first treatment element 2502 and the second treatment element 2506 may define different form factors from one another. All the embodiments shown in the accompanying figures are intended as non-limiting examples, and show only a few possible configurations for the therapeutic portion 2206 of the head 2204. The therapeutic portion 2206 may include a completely different design from what is specifically shown in the figures. In addition, the therapeutic portion 2206 may be custom-designed for the needs and anatomy of a particular user 108.

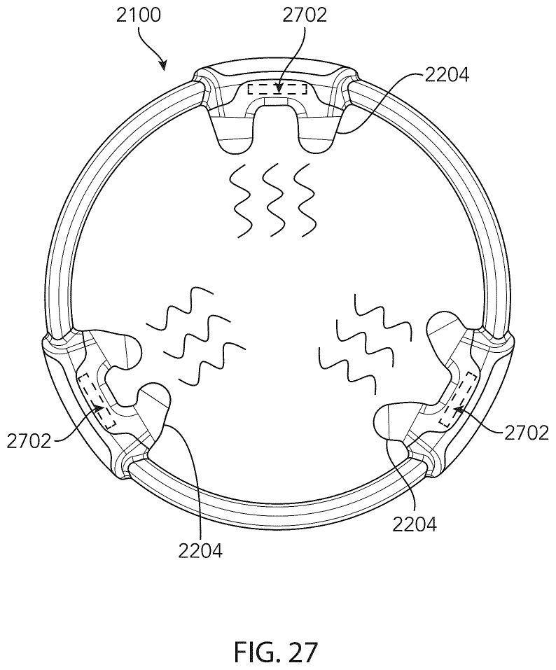

FIG. 27 illustrates that, in some embodiments, the massaging device 2100 includes a heat element 2702. The heat element 2702 may be electrically coupled to the massaging device 2100 and configured to warm the head 2204 such that when the head 2204 contacts the user 108, the user 108 feels the warmth along with the massaging pressure from the head 2204. Accordingly, the massaging device 2100 may be configured to provide heat therapy via the heat element 2702.

In some embodiments, as indicated in FIG. 27, the heat element 2702 is located within the head 2204. The heat element 2702 may be located elsewhere on and/or in the massaging device 2100, such as within the ring 2102 and/or the mount 2202. In some embodiments, the heat element 2702 is located within the docking station 2108 and is configured to transfer heat to the ring 2102, including the head 2204. The docking station 2108 may be configured to provide power to (i.e., “charge”) the heat element 2702 located on and/or in the ring 2102. At least one of the docking station 2108 and the ring 2102 may be powered via battery power. At least one of the docking station 2108 and the ring 2102 may be powered via a hardwired power supply, such as a wall outlet or other external power source. In some embodiments, the heat element 2702 is adjustable to allow the user 108 to control the amount of heat emitted, for example, by the head 2204.

In addition to emitting heat, the head 2204 may be configured to emit a cold sensation upon contact with the user 108. For example, the massaging device 2100 may include a cold element similar to the heat element 2702, where the cold element may be configured to chill the head 2204 and thereby provide cold therapy to the user 108. In some embodiments, the user 108 may store the head 2204 in a cold environment, such as a refrigerator or freezer, so that the head 2204 is kept cold prior to use.

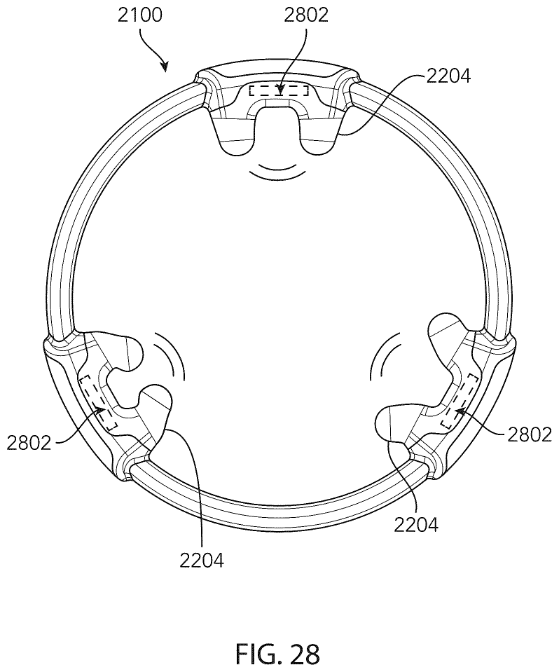

FIG. 28 illustrates that, in some embodiments, the massaging device 2100 includes a percussion element 2802. The percussion element 2802 may be electrically coupled to the massaging device 2100 and configured to agitate (e.g., vibrate, shake, pulsate, palpitate, and the like) the at head 2204 such that when the head 2204 contacts the user 108, the user 108 feels the agitation along with the massaging pressure from the head 2204. Accordingly, the massaging device 2100 may be configured to provide percussion therapy via the percussion element 2802. The addition of percussion therapy may allow the user 108 to experience a deeper massage.

In some embodiments, as indicated in FIG. 28, the percussion element 2802 is located within the head 2204. The percussion element 2802 may be located elsewhere on and/or in the massaging device 2100, such as within the ring 2102 and/or the mount 2202. In some embodiments, the percussion element 2802 is located within the docking station 2108. The docking station 2108 may be configured to provide power to (i.e., “charge”) the percussion element 2802 located on and/or in the ring 2102. At least one of the docking station 2108 and the ring 2102 may be powered via battery power. At least one of the docking station 2108 and the ring 2102 may be powered via a hardwired power supply, such as a wall outlet or other external power source. In some embodiments, the percussion element 2802 is adjustable to allow the user 108 to control the amount of agitation produced by the head 2204. The percussion element 2802 may include a motor configured to produce the vibration/agitation of the head 2204.

The massaging device 2100 may include one or both of the heat element 2702 and the percussion element 2802. It should be noted that the massaging device 2100 may include means to remotely control any powered component of the massaging device 2100, including the heat element 2702 and the percussion element 2802. For example, the massaging device 2100 may include a control panel, a timer, a remote control, an application on a smartphone or tablet, and/or the like, to operate the heat element 2702 and/or the percussion element 2802. Elements other than the heat element 2702 and the percussion element 2802 may be operable by a remote device, such as the first and/or second treatment elements 2502, 2506.

In some embodiments, the massaging device 2100 includes at least one washable cover configured to fit over the head 2204 to preserve the cleanliness of the head 2204. For example, when used by multiple people, such as in a clinic setting, it may be desirable to use a barrier to prevent direct contact between each user 108 and the head 2204. An individual user 108 and private owner of the massaging device 2100 may also use a cover to prevent any oil, sweat, or the like from contacting the head 2204. The cover may also provide additional traction when using the massaging device 2100. The cover may be made of fabric such as cotton or a polymer material, such as silicone. In addition, the head 2204 may be made of a material that is easy to clean with common cleaners, such as antiseptic wipes.

It should be noted that, though not shown in the figures, the massaging device 2100 may include a plurality of segments, substantially similar to the plurality of segments 1702 shown in FIG. 17. Further, the massaging device 2100 may be configured to add and/or remove at least one segment, as discussed with reference to FIG. 18.

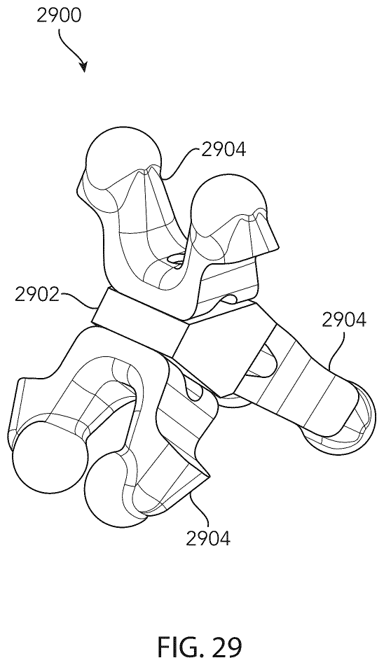

FIG. 29 illustrates a perspective view of a massaging device 2900. In some embodiments, the massaging device 2900 includes a central mount 2902 and a head 2904 coupled to the central mount 2902. The massaging device 2900 may include multiple heads 2904 coupled to the central mount 2902, as shown in FIG. 29. In some embodiments, the head 2904 is substantially similar to the head 2204 and the at least one head 106, and includes a therapeutic portion with at least one treatment element defining a specific configuration. The head 2904 may be configured to provide massaging pressure to a user 108. In some embodiments, the massaging device 2900 is sized and arranged to be a hand-held device, and may be ideal for use while traveling. The massaging device 2900 may be used while the user 108 is in a supine position, similar to FIGS. 9 and 10.

The head 2904 may be removably coupled to the central mount 2902. In some embodiments, the central mount 2902 is configured to couple to a power source configured to power a heat element, cold element, percussion element, and/or any other powered element of the massaging device 2900. The central mount 2902 may include an internal power element, such as one or more rechargeable batteries. The massaging device 2900 may be considered a smaller version of the massaging device 100 and/or the massaging device 2100, with many of the same capabilities (e.g., massaging pressure, heat therapy, and/or percussion therapy), just in a different orientation.

It should be noted that the massaging device 2900 may include means to remotely control any powered component of the massaging device 2900, including a heat element and/or a percussion element. For example, the massaging device 2900 may include a control panel, a timer, a remote control, an application on a smartphone or tablet, and/or the like, to operate a heat element and/or a percussion element. Elements other than a heat element and a percussion element may be operable by a remote device, such as any treatment elements of the head 2904.

In some embodiments, the massaging device 2900 includes at least one washable cover configured to fit over the head 2904 to preserve the cleanliness of the head 2904. For example, when used by multiple people, such as in a clinic setting, it may be desirable to use a barrier to prevent direct contact between each user 108 and the head 2904. An individual user 108 and private owner of the massaging device 2900 may also use a cover to prevent any oil, sweat, or the like from contacting the head 2904. The cover may also provide additional traction when using the massaging device 2900. The cover may be made of fabric such as cotton or a polymer material, such as silicone. In addition, the head 2904 may be made of a material that is easy to clean with common cleaners, such as antiseptic wipes.

Various components of the massaging devices 100, 2100, 2900 may be made of a combination of materials, including plastics, metals, and wood. In some embodiments, the housing 102, ring 2102, and central mount 2902 are made of a rigid plastic or rubber material. The housing 102 and/or ring 2102 may be made of a single piece of rigid material or multiple segments, as described herein. The housing 102 and/or ring 2102 may be made of a flexible chain-like material to allow the massaging device 100 and/or the massaging device 2100 to be easily collapsed and folded up for storage and/or travel.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely” or “nearly completely.” For example, the disclosure includes, “ . . . the enclosed shape 208 defines a substantially circular, or ring, shape . . . ” In this context, a “substantially circular shape” means that the enclosed shape is completely or nearly completely circular. However, the enclosed shape does not have to form a perfect circle to fall into the understanding of “substantially circular” as defined in this disclosure.

The term “adjacent” is used to mean “next to” or “adjoining.” For example, the disclosure includes, “ . . . where one end of one segment of the plurality of segments 1702 receives at least a portion of an adjacent end of another segment of the plurality of segments 1702.” In this context, an “adjacent end of another segment” means that the end of the other segment is “next to” or “adjoining” the end of the first segment.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A massaging device, comprising:
a housing defining a perimeter and a central open area;
at least one mount coupled to the housing along the perimeter; and
at least one head detachably coupled to the at least one mount;
wherein the central open area is configured to receive a portion of a user's body, and the at least one head is configured to provide pressure to the user's body.

2. The massaging device of claim 1, wherein the housing comprises an enclosed shape.

3. The massaging device of claim 1, wherein the at least one head comprises a plurality of heads each coupled to a corresponding mount, the plurality of heads spaced apart about the housing so as to be configured to provide symmetrical pressure about the user's body.

4. The massaging device of claim 3, wherein each head of the at least one head comprises a therapeutic portion having a configuration selected from the group consisting of a first configuration, a second configuration, a third configuration, and a fourth configuration.

5. The massaging device of claim 4, wherein the first configuration corresponds to a first portion of the user's body, the second configuration corresponds to a second portion of the user's body, the third configuration corresponds to a third portion of the user's body, and the fourth configuration corresponds to a fourth portion of the user's body, such that each of the first configuration, the second configuration, the third configuration, and the fourth configuration is configured to provide massaging pressure to each respective portion of the user's body.

6. The massaging device of claim 4, wherein the first configuration corresponds to a first user defining a first body size, the second configuration corresponds to a second user defining a second body size, the third configuration corresponds to a third user defining a third body size, and the fourth configuration corresponds to a fourth user defining a fourth body size, such that each of the first configuration, the second configuration, the third configuration, and the fourth configuration is configured to provide massaging pressure to the first user, the second user, the third user, and the fourth user, respectively.

7. The massaging device of claim 3, wherein the at least one head comprises:
a first head having a first configuration, wherein the first configuration corresponds to a first portion of the user's body and is configured to provide massaging pressure to the first portion;
a second head having a second configuration, wherein the second configuration corresponds to a second portion of the user's body and is configured to provide massaging pressure to the second portion; and
a third head having a third configuration, wherein the third configuration corresponds to a third portion of the user's body and is configured to provide massaging pressure to the third portion,
wherein each of the first head, the second head, and the third head is configured to interchangeably couple to each mount of the at least one mount.

8. The massaging device of claim 1, further comprising a base configured to receive and store the housing.

9. The massaging device of claim 8, wherein the massaging device is configured to be used while the housing is coupled to the base to thereby provide cervical traction to the user.

10. The massaging device of claim 1, wherein the housing comprises a plurality of segments mechanically coupled together to form the perimeter of the housing.

11. The massaging device of claim 10, wherein at least one segment of the plurality of segments is configured to be removed to reduce a size of the housing, and
wherein at least one additional segment is configured to be added to the plurality of segments to increase the size of the housing.

12. The massaging device of claim 1, further comprising a heat element electrically coupled to the massaging device, the heat element configured to warm a head of the at least one head and provide heat therapy to the user.

13. The massaging device of claim 1, further comprising a percussion element electrically coupled to the massaging device, the percussion element configured to cause a head of the at least one head to vibrate and provide percussion therapy to the user.

14. A massaging device, comprising:
a ring defining a perimeter and a central open area;
a mount coupled to the ring along the perimeter; and
a head detachably coupled to the mount, wherein the head comprises a therapeutic portion having a configuration selected from the group consisting of a first configuration, a second configuration, a third configuration, and a fourth configuration,
wherein the central open area is configured to receive a portion of a user's body, and the therapeutic portion of the head is configured to provide pressure to the user's body.

15. The massaging device of claim 14, wherein the therapeutic portion of the head comprises a first raised portion, a second raised portion spaced from the first raised portion, and a middle area located therebetween, wherein the first raised portion and the second raised portion are configured to provide pressure to the user's body.

16. The massaging device of claim 15, wherein the first raised portion comprises a first treatment element integrated into an end of the first raised portion and the second raised portion comprises a second treatment element integrated into an end of the second raised portion, wherein when the head is coupled to the mount, the first raised portion and the second raised portion extend away from the mount towards the central open area.

17. The massaging device of claim 16, wherein the first configuration comprises the first treatment element of the first raised portion angled toward the middle area of the therapeutic portion and the second treatment element of the second raised portion angled toward the middle area of the therapeutic portion.

18. The massaging device of claim 17, wherein the second configuration comprises the first treatment element of the first raised portion pointed toward the central open area of the ring and the second treatment element of the second raised portion pointed toward the central open area of the ring.

19. The massaging device of claim 18, wherein the third configuration comprises the first treatment element of the first raised portion angled away from the middle area of the therapeutic portion and the second treatment element of the second raised portion angled away from the middle area of the therapeutic portion.

20. The massaging device of claim 14, further comprising:
i) a heat element electrically coupled to the massaging device, the heat element configured to warm the head and provide heat therapy to the user;
ii) a percussion element electrically coupled to the massaging device, the percussion element configured to cause the head to vibrate and provide percussion therapy to the user;
iii) a docking station configured to receive and store the ring, the docking station further configured to charge at least one of the heat element and the percussion element; or
iv) any combination thereof.
